(19) United States
(12) Patent Application Publication
(10) Pub. No.: US 2025/0356842 A1
(43) Pub. Date: Nov. 20, 2025

(54) VOICE CHAT TRANSLATION

(71) Applicant: Roblox Corporation, San Mateo, CA (US)

(72) Inventors: Kyle Joseph SPENCE, Redwood City, CA (US); Andrew Gilmore FRANCIS, Monroe, WA (US)

(73) Assignee: Roblox Corporation, San Mateo, CA (US)

(21) Appl. No.: 18/871,452

(22) PCT Filed: Jun. 7, 2023
(86) PCT No.: PCT/US23/24734

§ 371 Date: Dec. 3, 2024

Related U.S. Application Data
(60) Provisional application No. 63/350,154, filed on Jun. 8, 2022.

(51) Int. Cl. G10L 13/08; G10L 13/02; H04L 51/04; H04L 51/063

(52) U.S. Cl. CPC G10L 13/08; G10L 13/02; H04L 51/04; H04L 51/063

(57) ABSTRACT

Implementations described herein relate to methods, systems, and computer-readable media to provide automatic translation of voice chat in virtual experiences. The automatic translation may retain context data and/or emotion data extracted from input speech received from a first user. The context data and/or emotion data may be used in translating the input speech into a second language for output to a second user at a user device.

### CROSS-REFERENCE TO RELATED APPLICATIONS

This application is a § 371 national stage of PCT International Application No. PCT/US2023/024734, filed Jun. 7, 2023, entitled “VOICE CHAT TRANSLATION,”, which claims the benefit of priority under 35 U.S.C. § 119(e) to U.S. Provisional Application Ser. No. 63/350,154, filed on Jun. 8, 2022, entitled “VOICE CHAT TRANSLATION,” the entire contents of which are hereby incorporated by reference herein.

### TECHNICAL FIELD

Embodiments relate generally to audio input and audio output via a computer device, and more particularly, to methods, systems, and computer-readable media for providing voice chat translation that retains user voice characteristics, context, and emotion in a virtual environment such as a metaverse place of a virtual metaverse.

### BACKGROUND

Computer audio (e.g., chat between users of computer devices) oftentimes consists of monaural or stereo audio being provided as it is received from a listening device or microphone. When audio is to be translated for various users speaking different languages, most solutions rely on text-based translations that provide simple functionality that includes only word-for-word or phrase translations presented in text. Therefore, much of the context and/or emotion associated with a user's directed chat may be lost in translation.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations of this application relate to providing voice chat translation in a virtual metaverse.

According to one aspect, a computer-implemented method comprises: receiving a request to translate audio associated with a chat function of metaverse place of the virtual metaverse, the audio received from a first user of a plurality of users, wherein the plurality of users are associated with the metaverse place; retrieving translation data associated with a second user of the plurality of users, wherein the translation data includes at least a language preference associated with the second user, and wherein the second user is associated with a user device: converting audio received from the first user into text, wherein the audio includes input speech in a first language spoken by the first user; translating the text into a second language, wherein the second language is defined by the language preference and wherein the translated text includes context data from the audio; converting the translated text into output speech including the context data; and providing the output speech to the user device.

In some implementations, the request identifies the first user and the second user, and the request originates from a computing device associated with the first user.

In some implementations, the method further comprising retrieving voice output preferences associated with the first user, wherein the voice output preferences at least partially override the translation data associated with the second user.

In some implementations, the method further comprising, prior to translating the text into the second language, moderating the text to remove words based on a text moderation filter.

In some implementations, the translating comprises providing, as input to a trained machine learning model, the text and receiving, as an output from the trained machine learning model, the translated text.

In some implementations, the context data comprises emotion data extracted from the audio.

In some implementations, the method further comprising pre-processing the audio to extract the emotion data.

In some implementations, converting the translated text into output speech comprises using a speech waveform modulator to create a modulated speech waveform that at least partially includes the context data.

In some implementations, the method further comprising translating the text into a plurality of different languages to create a plurality of different translated texts, and converting the plurality of different translated texts into a plurality of different output speech.

In some implementations, the method further comprising providing the plurality of different output speech to a plurality of user devices, wherein each output speech comprises utterances in a language associated with a respective user device of the plurality of user devices.

According to another aspect, a non-transitory computer-readable medium is disclosed with instructions stored thereon that, responsive to execution by a processing device, causes the processing device to perform operations comprising: receiving a request to translate audio associated with a chat function of metaverse place of the virtual metaverse, the audio received from a first user of a plurality of users, wherein the plurality of users are associated with the metaverse place; retrieving translation data associated with a second user of the plurality of users, wherein the translation data includes at least a language preference associated with the second user, and wherein the second user is associated with a user device; converting audio received from the first user into text, wherein the audio includes input speech in a first language spoken by the first user; translating the text into a second language, wherein the second language is defined by the language preference and wherein the translated text includes context data from the audio; converting the translated text into output speech including the context data: and providing the output speech to the user device.

In some implementations, the request identifies the first user and the second user, and the request originates from a computing device associated with the first user.

In some implementations, the operations further comprising retrieving voice output preferences associated with the first user, wherein the voice output preferences at least partially override the translation data associated with the second user.

In some implementations, the operations further comprising, prior to translating the text into the second language, moderating the text to remove words based on a text moderation filter.

In some implementations, the translating comprises providing, as input to a trained machine learning model, the text and receiving, as an output from the trained machine learning model, the translated text.

In some implementations, the context data comprises emotion data extracted from the audio.

In some implementations, the operations further comprising pre-processing the audio to extract the emotion data.

In some implementations, converting the translated text into output speech comprises using a speech waveform modulator to create a modulated speech waveform that at least partially includes the context data.

In some implementations, the operations further comprising: translating the text into a plurality of different languages to create a plurality of different translated texts; converting the plurality of different translated texts into a plurality of different output speech:;and providing the plurality of different output speech to a plurality of user devices, wherein each output speech comprises utterances in a language associated with a respective user device of the plurality of user devices.

According to yet another aspect, a system is disclosed, comprising: a memory with instructions stored thereon; and a processing device, coupled to the memory and operable to access the memory, wherein the instructions when executed by the processing device, cause the processing device to perform operations including: receiving a request to translate audio associated with a chat function of metaverse place of the virtual metaverse, the audio received from a first user of a plurality of users, wherein the plurality of users are associated with the metaverse place; retrieving translation data associated with a second user of the plurality of users, wherein the translation data includes at least a language preference associated with the second user, and wherein the second user is associated with a user device; converting audio received from the first user into text, wherein the audio includes input speech in a first language spoken by the first user: translating the text into a second language, wherein the second language is defined by the language preference and wherein the translated text includes context data from the audio: converting the translated text into output speech including the context data: and providing the output speech to the user device.

According to another aspect, portions, features, and implementation details of the systems, apparatuses, methods, and non-transitory computer-readable media disclosed herein may be combined to form additional aspects, including some aspects which omit and/or modify some or portions of individual components or features, include additional components or features, and/or other modifications: and all such modifications are within the scope of this disclosure.

### BRIEF DESCRIPTION OF THE DRAWINGS

FIG. 1 is a diagram of an example network environment for providing voice chat translation in a virtual metaverse, in accordance with some implementations.

FIG. 2 is a diagram of an example network environment for providing voice chat translation in a virtual metaverse, in accordance with some implementations.

FIG. 3 is a diagram of an example voice translation pipeline, in accordance with some implementations.

FIG. 4A is a diagram showing an example per-user voice machine learning model training method, in accordance with some implementations.

FIG. 4B is a diagram showing an example moderation and modulation of voice chat method, in accordance with some implementations.

FIG. 4C is a diagram showing an example player control of voice chat output method, in accordance with some implementations.

FIG. 4D is a diagram showing an example voice generation method, in accordance with some implementations.

FIG. 5 is a diagram showing an example voice machine learning model training method, in accordance with some implementations.

FIG. 6 is a flowchart of an example method to provide voice chat translation in a virtual metaverse, in accordance with some implementations.

FIG. 7 is a flowchart of an additional example method to provide voice chat translation in a virtual metaverse, in accordance with some implementations.

FIG. 8 is a block diagram illustrating an example computing device which may be used to implement one or more features described herein, in accordance with some implementations.

### DETAILED DESCRIPTION

One or more implementations described herein relate to voice chat translation associated with an online virtual experience platform. Features can include automatically converting speech into text while retaining context and/or emotion data, translating the text into a different language, and automatically generating speech from the translated text using the context and/or emotion data, in a metaverse place of a virtual metaverse. The generated speech retains at least a part of the context and/or emotion from the source speech.

Features described herein provide automatic translation of audio for output at client devices coupled to an online platform, such as, for example, an online virtual experience platform or an online gaming platform. The online platform may provide a virtual metaverse having a plurality of metaverse places associated therewith. Virtual avatars associated with users can traverse and join various metaverse places, and interact with items, characters, other avatars, and objects within the metaverse places. The avatars can move from one metaverse place to another metaverse place, while engaging in voice chat that provides for an immersive and enjoyable experience by allowing communication with users that speak different languages. Different audio streams from a plurality of users (avatars associated with a plurality of users) can be translated and provided to other users based on language preferences established by the users.

Through automatic translation with retention of context and/or emotion, users can accurately understand context and/or emotion through chat despite language hurdles. This may provide a more immersive and enjoyable experience for users of a virtual experience platform.

Online virtual experience platforms and online gaming platforms (also referred to as “user-generated content platforms” or “user-generated content systems”) offer a variety of ways for users to interact with one another. For example, users of an online virtual experience platform may create games or other content or resources (e.g., characters, graphics, items for game play and/or use within a virtual metaverse, etc.) within the online platform.

Users of an online virtual experience platform may work together towards a common goal in a metaverse place, game, or in game creation; share various virtual items (e.g., inventory items, game items, etc.); engage in audio chat (e.g., audio chat with automatic translation), send electronic messages to one another, and so forth. Users of an online virtual experience platform may interact with others and play games, e.g., including characters (avatars) or other game objects and mechanisms. An online virtual experience platform may also allow users of the platform to communicate with each other. For example, users of the online virtual experience platform may communicate with each other using voice messages or live voice interaction (e.g., via voice chat with automatic translation), text messaging, video messaging (e.g., including audio translation), or a combination of the above. Some online virtual experience platforms can provide a virtual three-dimensional environment or multiple environments linked within a metaverse, in which users can interact with one another or play an online game.

In order to help enhance the entertainment value of an online virtual experience platform, the platform can provide rich audio for playback at a user device. The audio can include, for example, different audio streams from different users, as well as background audio. According to various implementations described herein, the different audio streams can be captured and automatically translated based on the user that is listening. For example, a first user may request to engage in voice chat with automatic translation with a second user. Thereafter, audio streams from the first user may be translated prior to being provided to the second user. Additionally, the audio streams may also be provided to other users with or without automatic translation, for example, based upon user settings, language settings, override settings, and/or other settings.

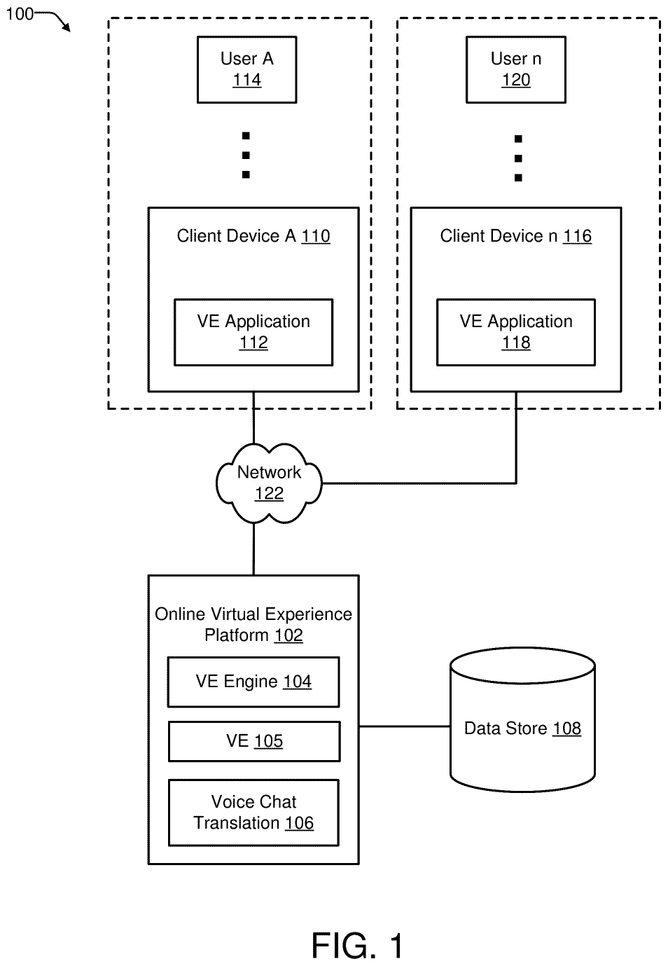

### FIGS. 1-3: Example System Architecture

FIG. 1 illustrates an example network environment 100, in accordance with some implementations of the disclosure. The network environment 100 (also referred to as “system” herein) includes an online virtual experience platform 102, a first client device 110, a second client device 116 (generally referred to as “client devices 110/116” herein), all connected via a network 122. The online virtual experience platform 102 can include, among other things, a virtual experience engine 104, one or more virtual experiences 105, a voice chat translation component 106, and a data store 108.

The client device 110 can include a virtual experience application 112, and the client device 116 can include a virtual experience application 118. Users 114 and 120 can use client devices 110 and 116, respectively, to interact with the online virtual experience platform 102 and with other users utilizing the online virtual experience platform 102.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-FiR; network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience platform 102 can include a server having one or more computing devices (e.g., a cloud computing system, a rackmount server, a server computer, cluster of physical servers, virtual server, etc.). In some implementations, a server may be included in the online virtual experience platform 102, be an independent system, or be part of another system or platform.

In some implementations, the online virtual experience platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience platform 102 and to provide a user with access to online virtual experience platform 102. The online virtual experience platform 102 may also include a website (e.g., one or more webpages) or application back-end software that may be used to provide a user with access to content provided by online virtual experience platform 102. For example, users 114/120 may access online virtual experience platform 102 using the virtual experience application 112/118 on client devices 110/116, respectively.

In some implementations, online virtual experience platform 102 may include a type of social network providing connections between users or a type of user-generated content system that allows users (e.g., end-users or consumers) to communicate with other users via the online virtual experience platform 102, where the communication may include voice chat (e.g., synchronous and/or asynchronous voice communication with or without automatic translation), video chat (e.g., synchronous and/or asynchronous video communication with or without automatic audio translation), or text chat (e.g., synchronous and/or asynchronous text-based communication with or without automatic text translation).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience platform 102 may be a virtual gaming platform. For example, the gaming platform may provide single-player or multiplayer games to a community of users that may access or interact with games (e.g., user generated games or other games) using client devices 110/116 via network 122. In some implementations, games (also referred to as “video game.” “online game.” “metaverse place.” or “virtual experiences” herein) may be two-dimensional (2D) games, three-dimensional (3D) games (e.g., 3D user-generated games), virtual reality (VR) games, or augmented reality (AR) games, for example. In some implementations, users may search for games and game items, and participate in gameplay with other users in one or more games. In some implementations, a game may be played in real-time with other users of the game. Similarly, some users may engage in real-time voice or video chat with other users of the game. As described herein, the real-time voice or video chat may include automatic translation.

In some implementations, other collaboration platforms can be used with the features described herein instead of or in addition to online virtual experience platform 102 and/or voice chat translation component 106. For example, a social networking platform, purchasing platform, messaging platform, creation platform, etc. can be used with the automatic translation features such that translated audio is provided to users outside of games and/or virtual experiences.

In some implementations, gameplay may refer to interaction of one or more players using client devices (e.g., 110 and/or 116) within a game (e.g., virtual experience 105) or the presentation of the interaction on a display or other output device of a client device 110 or 116. In some implementations, gameplay instead refers to interaction within a virtual experience or metaverse place, and may include objectives that are dissimilar, different, or the same as some games. Furthermore, although referred to as “players,” the terms “avatars,” “users,” and/or other terms may be used to refer to users engaged with and/or interacting with an online virtual experience.

One or more virtual experiences 105 are provided by the online virtual experience platform. In some implementations, a virtual experience 105 can include an electronic file that can be executed or loaded using software, firmware or hardware configured to present the virtual content (e.g., digital media item) to an entity. In some implementations, a virtual experience application 112/118 may be executed and a virtual experience 105 rendered in connection with a virtual experience engine 104. In some implementations, a virtual experience 105 may have a common set of rules or common goal, and the virtual environments of a virtual experience 105 share the common set of rules or common goal. In some implementations, different virtual experiences may have different rules or goals from one another.

In some implementations, games and/or virtual experiences may have one or more environments (also referred to as “gaming environments.” “metaverse places,” or “virtual environments” herein) where multiple environments may be linked. An example of an environment may be a three-dimensional (3D) environment. The one or more environments of a virtual experience 105 or virtual experience may be collectively referred to as a “world,” “gaming world.” “virtual world.” “universe,” or “metaverse” herein. An example of a world may be a 3D metaverse place of a virtual experience 105. For example, a user may build a metaverse place that is linked to another metaverse place created by another user, different from the first user. A character of the virtual experience may cross the virtual border to enter the adjacent metaverse place. Additionally, sounds, theme music, and/or background music may also traverse the virtual border such that avatars standing within proximity of the virtual border may listen to audio that includes at least a portion of the sounds emanating from the adjacent metaverse place.

It may be noted that 3D environments or 3D worlds use graphics that use a three-dimensional representation of geometric data representative of content (or at least present content to appear as 3D content whether or not 3D representation of geometric data is used). 2D environments or 2D worlds use graphics that use two-dimensional representation of geometric data representative of game content.

In some implementations, the online virtual experience platform 102 can host one or more virtual experiences 105 and can permit users to interact with the virtual experiences 105 (e.g., search for experiences, games, game-related content, virtual content, or other content) using a virtual experience application 112/118 of client devices 110/116. Users (e.g., 114 and/or 120) of the online virtual experience platform 102 may play, create, interact with, or build virtual experiences 105, search for virtual experiences 105, communicate with other users, create and build objects (e.g., also referred to as “item(s)” or “game objects” or “virtual game item(s)” herein) of virtual experiences 105, and/or search for objects. For example, in generating user-generated virtual items, users may create characters, decoration for the characters, one or more virtual environments for an interactive game, or build structures used in a virtual experience 105, among others.

In some implementations, users may buy, sell, or trade virtual game objects, such as in-platform currency (e.g., virtual currency), with other users of the online virtual experience platform 102. In some implementations, online virtual experience platform 102 may transmit game content to game applications (e.g., virtual experience application 112). In some implementations, game content (also referred to as “content” herein) may refer to any data or software instructions (e.g., game objects, game, user information, video, images, commands, media items, etc.) associated with online virtual experience platform 102 or game applications.

In some implementations, game objects (e.g., also referred to as “item(s)” or “objects” or “virtual game item(s)” herein) may refer to objects that are used, created, shared or otherwise depicted in virtual experiences 105 of the online virtual experience platform 102 or virtual experience applications 112 or 118 of the client devices 110/116. For example, game objects may include a part, model, character, tools, weapons, clothing, buildings, vehicles, currency, flora, fauna, components of the aforementioned (e.g., windows of a building), and so forth.

It may be noted that the online virtual experience platform 102 hosting virtual experiences 105, is provided for purposes of illustration, rather than limitation. In some implementations, online virtual experience platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 105 may be associated with a particular user or a particular group of users (e.g., a private game), or made widely available to users of the online virtual experience platform 102 (e.g., a public game). In some implementations, where online virtual experience platform 102 associates one or more virtual experiences 105 with a specific user or group of users, online virtual experience platform 102 may associated the specific user(s) with a virtual experience 105 using user account information (e.g., a user account identifier such as username and password). Similarly, in some implementations, online virtual experience platform 102 may associate a specific developer or group of developers with a virtual experience 105 using developer account information (e.g., a developer account identifier such as a username and password).

In some implementations, online virtual experience platform 102 or client devices 110/116 may include a virtual experience engine 104 or virtual experience application 112/118. The virtual experience engine 104 can include a virtual experience application similar to virtual experience application 112/118. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, machine learning models, translation components, spatialized audio manager/engine, audio mixers, audio subscription exchange, audio subscription logic, audio subscription prioritizers, real-time communication engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) and translate audio (e.g., convert audio to text, translate the text, convert translated text to speech, etc.). In some implementations, virtual experience applications 112/118 of client devices 110/116, respectively, may work independently, in collaboration with virtual experience engine 104 of online virtual experience platform 102, or a combination of both.

In some implementations, both the online virtual experience platform 102 and client devices 110/116 execute a virtual experience engine (104. 112, and 118, respectively). The online virtual experience platform 102 using virtual experience engine 104 may perform some or all the virtual experience engine functions (e.g., generate physics commands, rendering commands, spatialized audio commands, etc.), or offload some or all the virtual experience engine functions to virtual experience engine 104 of client device 110. In some implementations, each virtual experience 105 may have a different ratio between the virtual experience engine functions that are performed on the online virtual experience platform 102 and the virtual experience engine functions that are performed on the client devices 110 and 116.

For example, the virtual experience engine 104 of the online virtual experience platform 102 may be used to generate physics commands in cases where there is a collision between at least two virtual objects, while the additional virtual experience engine functionality (e.g., generate rendering commands or combining spatialized audio streams) may be offloaded to the client device 110. In some implementations, the ratio of virtual experience engine functions performed on the online virtual experience platform 102 and client device 110 may be changed (e.g., dynamically) based on gameplay conditions. For example, if the number of users participating in gameplay of a virtual experience 105 exceeds a threshold number, the online virtual experience platform 102 may perform one or more virtual experience engine functions that were previously performed by the client devices 110 or 116.

For example, users may be engaging with a virtual experience 105 on client devices 110 and 116, and may send control instructions (e.g., user inputs, such as right, left, up, down, user election, or character position and velocity information, etc.) to the online virtual experience platform 102. Subsequent to receiving control instructions from the client devices 110 and 116, the online virtual experience platform 102 may send gameplay instructions (e.g., position and velocity information of the characters participating in the group gameplay or commands, such as rendering commands, collision commands, spatialized audio commands, etc.) to the client devices 110 and 116 based on control instructions. For instance, the online virtual experience platform 102 may perform one or more logical operations (e.g., using virtual experience engine 104) on the control instructions to generate gameplay instruction for the client devices 110 and 116. In other instances, online virtual experience platform 102 may pass one or more or the control instructions from one client device 110 to other client devices (e.g., 116) participating in the virtual experience 105. The client devices 110 and 116 may use the gameplay instructions and render the gameplay for presentation on the displays of client devices 110 and 116.

In some implementations, the control instructions may refer to instructions that are indicative of in-experience actions of a user's character. For example, control instructions may include user input to control the in-experience action, such as right, left, up, down, user selection, gyroscope position and orientation data, force sensor data, etc. The control instructions may include character position and velocity information. In some implementations, the control instructions are sent directly to the online virtual experience platform 102. In other implementations, the control instructions may be sent from a client device 110 to another client device (e.g., 116), where the other client device generates gameplay instructions using the local virtual experience engine 104. The control instructions may include instructions to play a voice communication message or other sounds from another user on an audio device (e.g., speakers, headphones, etc.).

In some implementations, gameplay instructions may refer to instructions that allow a client device 110 (or 116) to render gameplay of a virtual experience, such as a multiplayer game or virtual experience. The gameplay instructions may include one or more of user input (e.g., control instructions), character position and velocity information, or commands (e.g., physics commands, rendering commands, collision commands, etc.).

In some implementations, characters (or virtual objects generally) are constructed from components, one or more of which may be selected by the user, that automatically join together to aid the user in editing. One or more characters (also referred to as an “avatar” or “model” herein) may be associated with a user where the user may control the character to facilitate a user's interaction with the game 105. In some implementations, a character may include components such as body parts (e.g., head, hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, the user may also control the scale (e.g., height, width, or depth) of a character or the scale of components of a character. In some implementations, the user may control the proportions of a character (e.g., blocky, anatomical, etc.). It may be noted that in some implementations, a character may not include a character game object (e.g., body parts, etc.) but the user may control the character (without the character game object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience platform 102. In some implementations, creating, modifying, or customizing characters, other virtual objects, virtual experiences 105, or virtual environments may be performed by a user using a user interface (e.g., developer interface) and with or without scripting (or with or without an application programming interface (API)). It may be noted that for purposes of illustration, rather than limitation, characters are described as having a humanoid form. In may further be noted that characters may have any form such as a vehicle, animal, inanimate object, or other creative form.

In some implementations, the online virtual experience platform 102 may store characters created by users in the data store 108. In some implementations, the online virtual experience platform 102 maintains a character catalog and virtual experience catalog that may be presented to users via the virtual experience engine 104, virtual experience 105, and/or client device 110/116. In some implementations, the virtual experience catalog includes images of virtual experiences stored on the online virtual experience platform 102. In addition, a user may select a character (e.g., a character created by the user or other user) from the character catalog to participate in the chosen experience. The character catalog includes images of characters stored on the online virtual experience platform 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience platform 102.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online virtual experience platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the virtual experience application 112 or 118, respectively. In one implementation, the virtual experience application 112 or 118 may permit users to use and interact with online virtual experience platform 102, such as search for a virtual experience, virtual item, or other content; control a virtual character in a virtual experience hosted by online virtual experience platform 102, or view or upload content, such as virtual experiences 105, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to client device 110 or 116 and allows users to interact with online virtual experience platform 102. The virtual experience application may render, display, or present the content (e.g., a web page, a user interface, a media viewer, an audio stream) to a user. In an implementation, the virtual experience application may also include an embedded media player that is embedded in a web page.

According to aspects of the disclosure, the virtual experience application 112/118 may be an online virtual experience platform application for users to build, create, edit, upload content to the online virtual experience platform 102 as well as interact with online virtual experience platform 102 (e.g., play virtual experiences 105 hosted by online virtual experience platform 102). As such, the virtual experience application 112/118 may be provided to the client device 110 or 116 by the online virtual experience platform 102. In another example, the virtual experience application 112/118 may be an application that is downloaded from a server.

In some implementations, a user may login to online virtual experience platform 102 via the virtual experience application. The user may access a user account by providing user account information (e.g., username and password) where the user account is associated with one or more characters available to participate in one or more virtual experiences 105 of online virtual experience platform 102.

In general, functions described as being performed by the online virtual experience platform 102 can also be performed by the client device(s) 110 or 116, or a server, in other implementations if appropriate. In addition, the functionality attributed to a particular component can be performed by different or multiple components operating together. The online virtual experience platform 102 can also be accessed as a service provided to other systems or devices through appropriate application programming interfaces (APIs), and thus is not limited to use in websites.

In some implementations, online virtual experience platform 102 may include a voice chat translation component 106.

In some implementations, the voice chat translation component 106 may include an application programming interface (API) comprising a suite of computer-executable code that provides functionality to users and/or developers in the form of function calls that allow software components to communicate and/or provide/receive data. The API includes a plurality of defined software functions that are related to voice chat translation, which can be used by developers to enable audio translation functionality for voice chat and video chat, and can include any function related to audio playback at a user device.

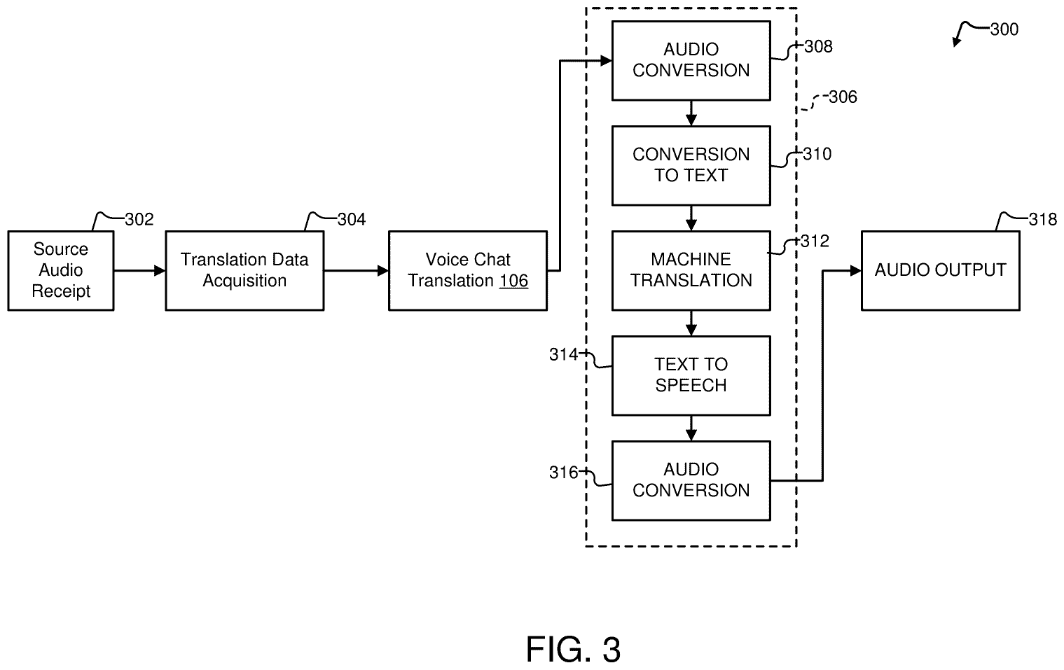

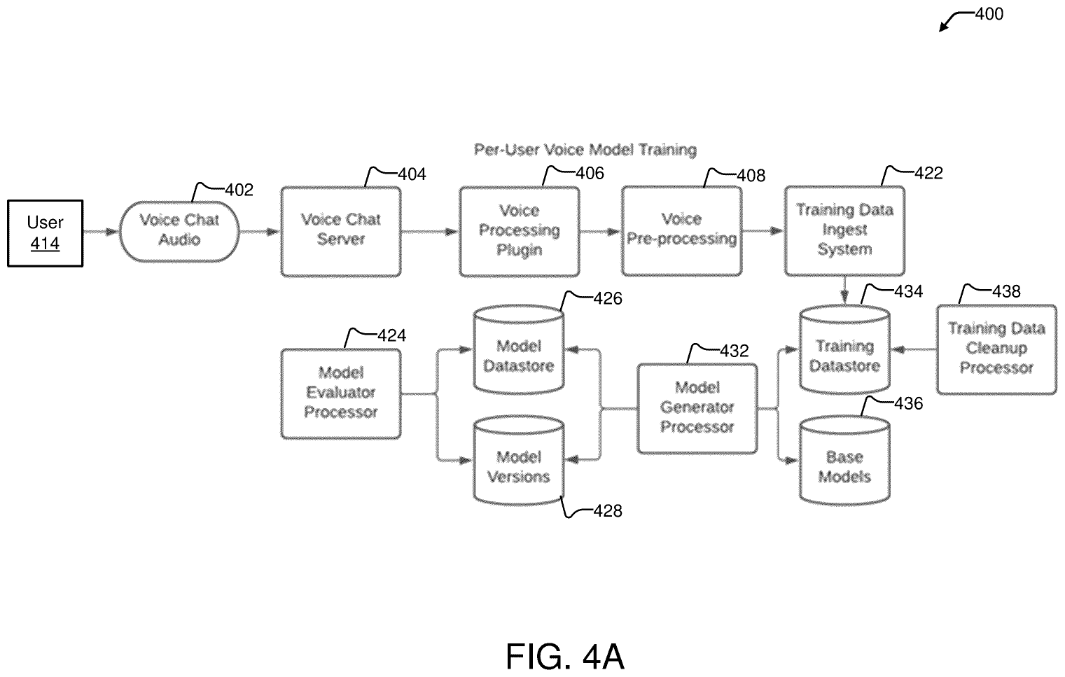

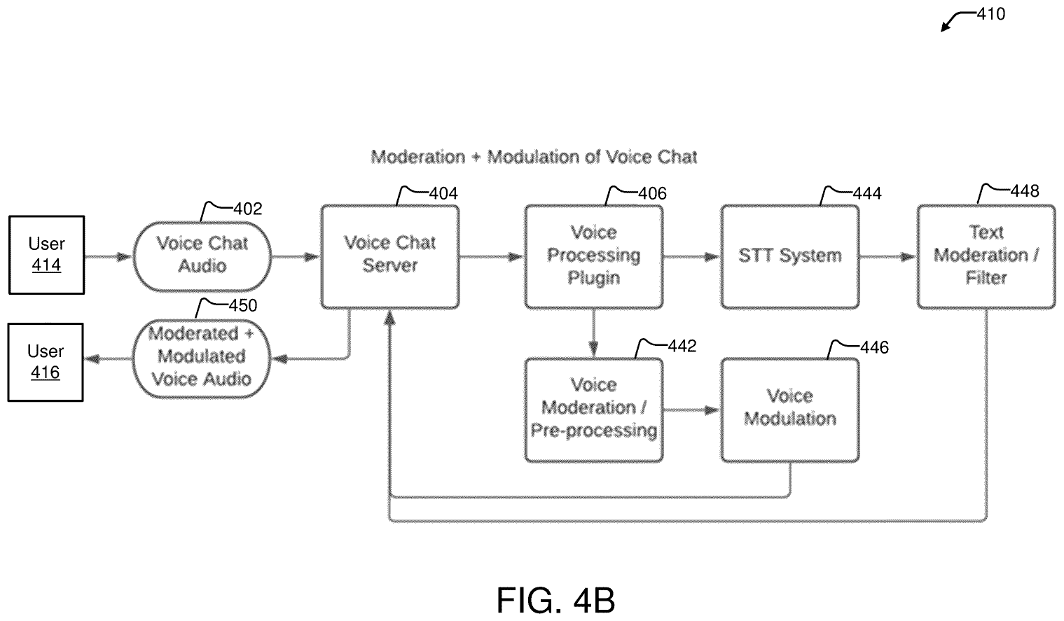

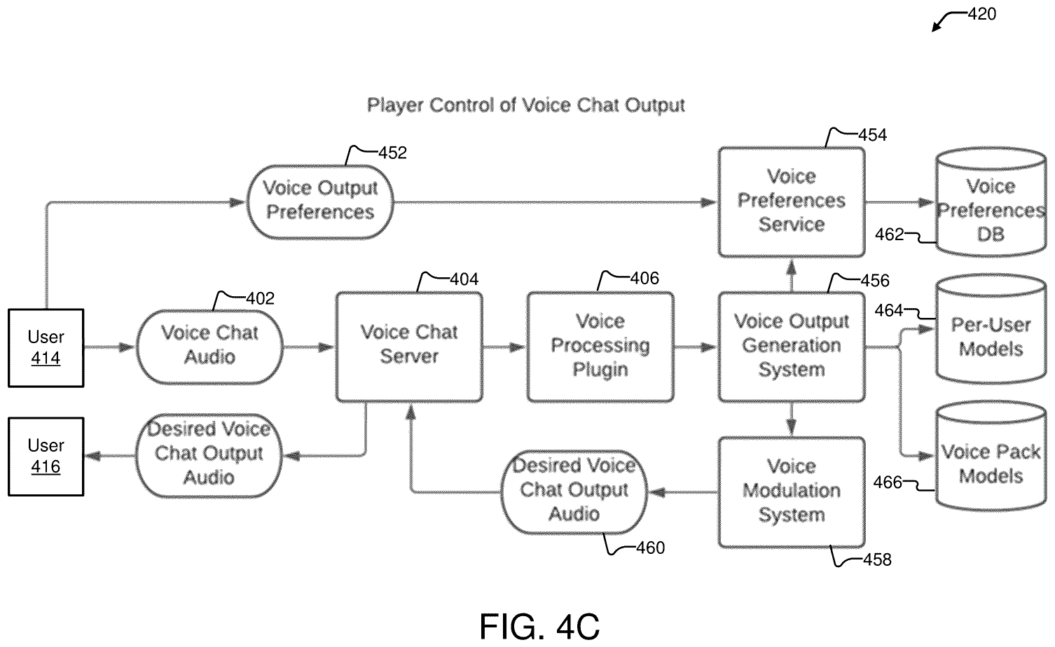

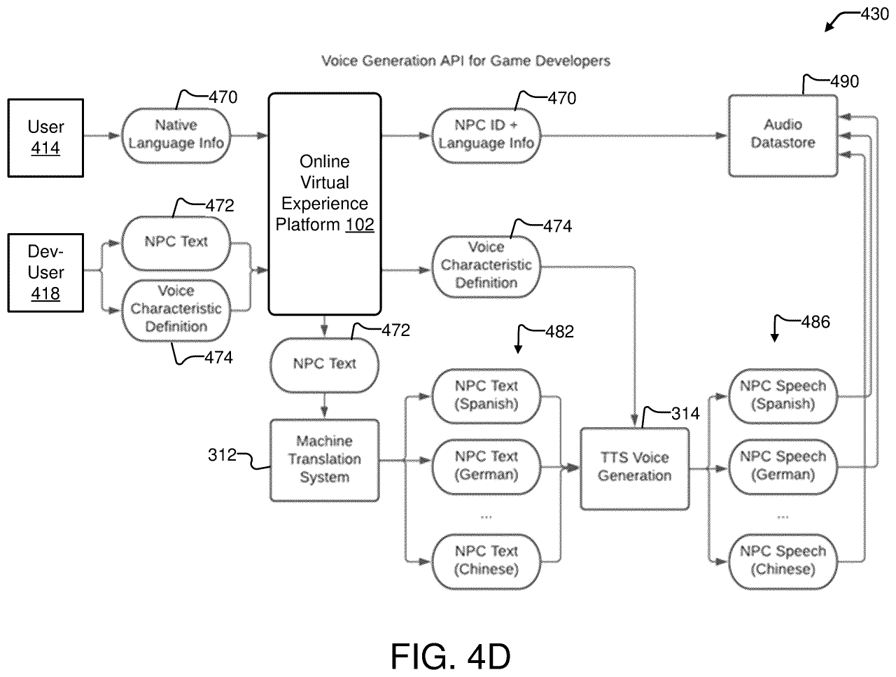

In some implementations, the voice chat translation component 106 is a software component that provides automatic voice chat translation functionality based on user settings. For example, in some implementations, the voice chat translation component may include one or more machine learning models, one or more text translation components, one or more audio conversion components, one or more text-to-speech components, one or more plugins for communication with a plurality of third-party services, and/or any other suitable components. FIG. 3 and FIG. 4 illustrate different sub-components that may be included as part of the voice chat translation component 106, in some implementations.

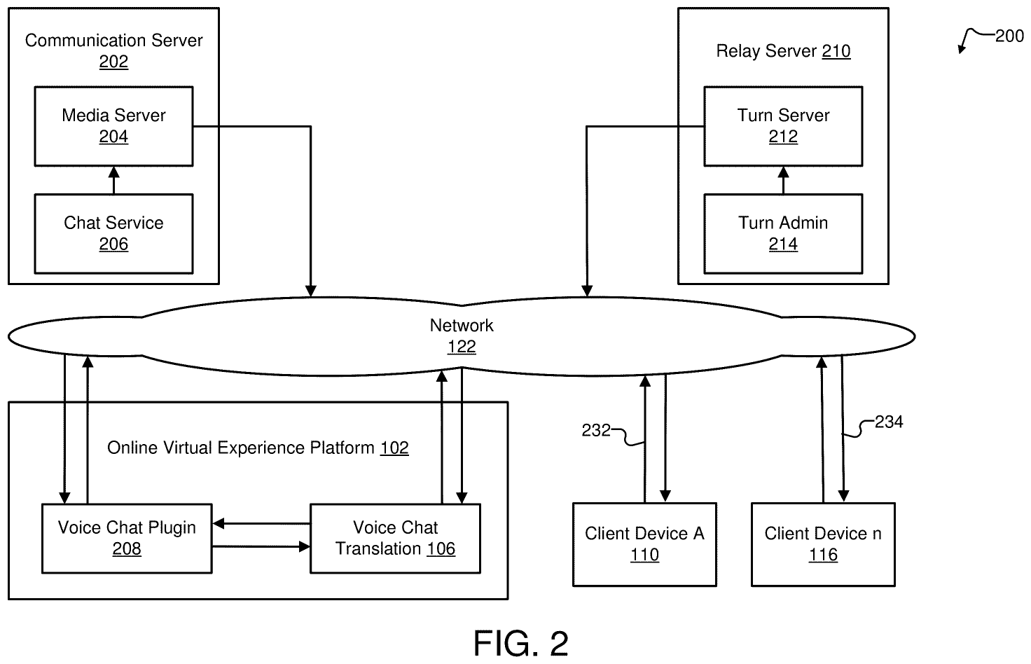

Hereinafter, operation of the online virtual experience platform 102 with regard to providing automatic voice chat translation, is described more fully with reference to FIG. 2.

FIG. 2 is a diagram of an example network environment 200 (e.g., a subset of the network environment 100) for providing automatic voice chat translation in a virtual metaverse, in accordance with some implementations. Network environment 200 is provided for illustration. In some implementations, the network environment 200 may include the same, fewer, more, or different elements configured in the same or different manner as that shown in FIG. 2.

As shown in FIG. 2, the online virtual experience platform 102 may be in communication with client device 110 and client device 116 such that a user audio stream 232 is received from the client device 110, and a translated audio stream 234 is provided for output at the client device 116, over the network 122. The online virtual experience platform 102 may also be in communication with communication server 202 and relay server 210 over the network 122.

The online virtual experience platform 102, in addition to those components illustrated in FIG. 1, may include a voice chat plugin 208 for communication with the communication server 202. The voice chat plugin 208 may perform the separation of audio streams and/or the identification of audio streams to be translated by the voice chat translation component 106. In this manner, while the audio stream 232 may be sent in its native form to any client device, the voice chat plugin 208 may also indicate to the media server 204 that translated versions of the audio stream 232 are to be provided to other client devices. Accordingly, the voice chat plugin 208 may both allow native communication and translated communication to occur at substantially the same or similar times.

The communication server 202 may be a third-party communication server and/or a separate server existing within the online virtual experience platform 100. The communication server 202 may include a media server 204 in operative communication with a chat service 206.

The media server 204 is a server configured to connect and communicate audio streams (or other data) between components of the network environment 100. The media server 204 may facilitate real-time communication, for example, among various client devices and between each client device and the online virtual experience server 102.

The chat service 206 may be a software service configured to enable voice chat and/or video chat (with audio) between client devices and the online virtual experience server 102.

The relay server 210 may be a third-party relay server and/or a separate server existing on the online virtual experience platform 100. The relay server 210 may include a turn server 212 in operative communication with a turn administration component 214.

The turn server 212 may implement a Traversal Using Relay NAT (TURN) protocol. It may relay network traffic. For example, the turn server 212 may support communication between client devices 110 and 116 over network 122.

The turn administration component 214 may implement communication protocols and control messaging with the turn server 212, in addition to other functions.

Hereinafter, translation of audio for chat, utilizing the voice chat translation component 106 and available translation data, is described more fully with reference to FIG. 3.

FIG. 3 is a diagram of an example voice translation pipeline 300 for automatically translating voice chat (or video chats with audio) in a virtual metaverse, in accordance with some implementations. Pipeline 300 is provided for illustration. In some implementations, the pipeline 300 may include the same, fewer, more, or different elements configured in the same or different manner as that shown in FIG. 3.

As shown in FIG. 3, the pipeline 300 begins with receipt of source audio from a voice chat (or a video chat) at stage 302. The source audio may be associated with translation data that is acquired at stage 304. The translation data may include user settings for translation, language settings, and other user settings.

Upon acquisition of the translation data and the receipt of audio, the voice chat translation component 106 may begin translation (e.g., as shown in the dotted box 306).

At stage 308 the source audio may be converted from a form received from the media server 202 into another format suitable for text extraction. For example, if the media server 202 uses a first format (e.g., OPUS), the stage 308 may include converting from the first format into the second format (e.g., WAV).

At stage 310, the (optionally) converted audio is converted into text. For example, the converted audio may be processed to extract phonemes or other audio cues, and those phonemes or other audio cues may be used to extrapolate text. In some implementations, a trained machine learning model is used to convert the audio into text.

At stage 312, a machine translation of the text is performed to translate the text from a first language into a second language. The machine translation may retain context data and/or emotion data. For example, the context data and/or emotion data may be identified through use of a trained machine learning model that identifies context and/or emotion from phrases, phonemes, audio cues, accentuation, stresses, etc. in the received audio stream. In some implementations, context data may include particular stresses, accentuation, and other attributes from a first speaker. In these and other implementations, emotion data may be extracted from the context data (e.g., by identifying stronger emotions with stronger accentuations/stresses, and so forth). In some implementations, a trained machine learning model or sub-model may pre-process audio to identify context data and/or emotion data for use in translation speech waveforms (e.g., by modulating to increase or decrease emotion within the synthesized speech).

In some implementations, the context data and/or emotion data may additionally be identified based on analysis of video or animation (when the chat is video chat) that is included in the received data. Such analysis may be performed by a trained machine learning model or other technique that is configured to identify emotion from one or more frames of video or animation.

At stage 314, the translated text is converted into speech with a speech synthesizer or TTS (text-to-speech). The speech synthesizer may also utilize the context data and/or emotion data to alter a produced speech waveform (or directly in the generation process) to output speech that conveys the same context and/or emotion. For example, the speech synthesizer may receive input emotion data and provide accented pronunciations in the output speech that are reflective of emotion indicated by the emotion data. For example, the speech synthesizer may provide fluctuating speech patterns reflective of context indicated by the context data. For example, if the received audio is from an indoor context with echoes or background noise, the output waveform may be generated to include echoes or the background noise.

Other techniques to improve translation of emotion and context may also be utilized. For example, a speech-to-speech translation system that allows expressiveness in translations may be based on phonemes. Voice can be broken down into phonemes with some variance between different languages and their dialects. A probability matrix may be based on the person who is talking and the language characteristics of their source language. Using this probability matrix the most likely phonemes that follow other phonemes can be effectively rendered and/or probabilistically identified.

At stage 316, the speech waveform is (optionally) converted from the second format back into the first format. In this manner, the audio output stage 318 may provide an audio stream that can be input by the media server 302 and directed to a chat recipient in a similar manner as un-translated voice chats.

Hereinafter, brief descriptions of several example methods of performing automatic voice chat translation are described with reference to FIGS. 4A-4D.

### FIGS. 4A-4D: Example Methods of Automatic Voice Translation

FIG. 4A is a diagram showing an example per-user voice machine learning model training method 400, in accordance with some implementations. As shown, the method 400 may include the training of one or more machine learning models on a per-user basis. The method 400 may also include storing of models that are trained and associated with a particular user to provide increased accuracy in translations. The multiple trained models may also be used in multi-lingual translations. The method 400 may use transfer learning techniques in some implementations.

As shown in FIG. 4A, a user 414 may provide input voice chat audio 402 to a voice chat server 404 (or the server 102). A voice processing plugin 406 and voice pre-processing stage 408 may filter and/or remove noise or other artifacts from the audio 402. Thereafter, a training data injection system 422 may generate training records to train a machine learning model, and store the training record at training datastore 434. In some implementations, a training data cleanup processor 438 may adjust the stored training records.

Thereafter, or at substantially the same time, a machine learning model evaluator processor 424 and machine learning model generator processor 432 may generate data models representative of the machine learning models under training and store them at mode datastore 426. Similarly, different machine learning model versions may be stored in datastore 428. Reference models and/or base models may be stored and/or retrieved from data store 436 for use in training to create the models stored at 426/428.

As shown in FIG. 4A, machine learning models may be generated, trained, and adjusted on a per-user basis in some implementations. In this manner, speedier voice chat translations with improved context and/or emotion may be effectuated. Other variations including machine learning models based on specific dialects, specific languages, and others, may be implemented in alternative to, or in combination with, per-user models in some implementations.

FIG. 4B is a diagram showing an example moderation and modulation of voice chat method 410, in accordance with some implementations. As shown, the method 410 may include extending a voice translation system to include trust and safety features allowing any audience (e.g., a younger audience for which certain content may be inappropriate or impermissible) to safely participate in voice chat. The method 410 may filter out inappropriate voice chat messages, block audio that does not include a voice, and allow user to modulate how voices sound to recipients of the voice chat.

As shown in FIG. 4B, user 414 initiates a chat request to chat with user 416. Voice chat audio 402 is transmitted from a user device associated with user 414, to voice chat server 404 (or server 102). Voice processing plugin 406 transmitted processed audio waveforms to the speech-to-text (STT) system 444, to create text. The text may then undergo text moderation and/or filtering 448 to remove offensive or moderated content.

In some implementations, a voice modulation preprocessor 442 and voice modulation 446 steps may be performed to modulate a synthesized speech waveform to mimic emotion in a translated language. Additionally, in some implementations where direct phoneme translation may be used, the pre-processing 442 may also include moderation activities based on phonemes associated with moderated content.

FIG. 4C is a diagram showing an example player control of voice chat output method 420, in accordance with some implementations. As shown, the method 420 may include a voice modulation system 458 to allow users to control how their voice sounds to other users.

As shown in FIG. 4C, user 414 may request to chat with user 416. Voice chat audio 402 is provided to a voice chat server 404 (or server 102) and undergoes voice processing 406 as described above. In some implementations, voice output preferences 452 (i.e., including override preferences and other preferences associate with user 414) are transmitted to a voice preferences service 454 for storage at datastore 462.

Voice output generation system 456 may retrieve per-user trained machine learning models from datastore 464 and/or voice pack models from datastore 466 for use in synthesizing a speech waveform from translated text. Thereafter, voice modulation system 458 may create a desired voice chat output audio that is transmitted to the voice chat server 404, and routed to the user 416.

FIG. 4D is a diagram showing an example voice generation method 430, in accordance with some implementations. As shown, the method 430 may include a voice generation application programming interface (API) that is exposed to developers. The developers, using the exposed API, may add voices to non-player characters (NPCs) using text inputs, and may also include localized voices based on the speech translation pipeline 300. For example, multilingual outputs may be provided for different text input by developers for output in different regions.

As shown in FIG. 4D, native language information 470, NPC text information 472, and voice characteristic definitions 474 may be provided to the platform 102, which are then routed to audio datastore 490, machine translation system 312, and text-to-speech (TTS) voice generation system 314. The machine translation system may generate a plurality of different translated text 482 for generation of a plurality of output speech 486, each in different languages associated with a target computing device and/or user device. In addition, while noted as being associated with NPCs, the same may be varied to include multiple translations of user chat such that multiple different recipients, each speaking different languages, may engage in chat.

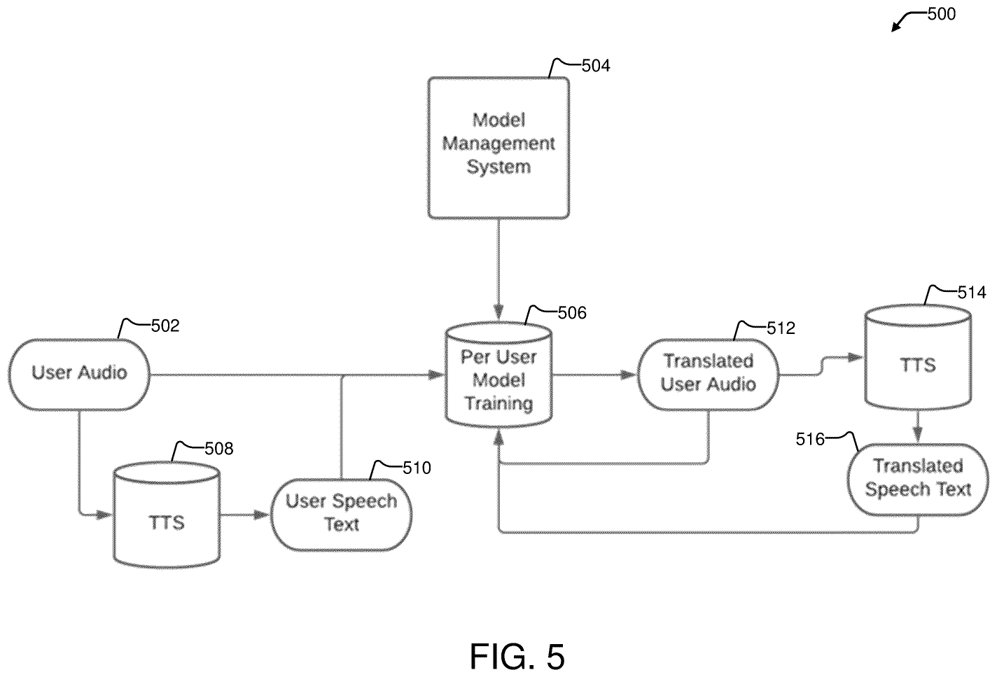

FIG. 5 is a diagram showing an example voice machine learning model training method 500, in accordance with some implementations. As shown, the method 500 may include training machine learning models with higher confidence through the use of back propagation and text to speech services.

For example, user audio 502 may be used to create text 510 through STT component 508. A model management system 504 may implemented a per-user model training method 506 using translated user audio 512 and translated speech text 516 in back propagation to improve accuracy.

Other variations on the example method of FIG. 5 are applicable in some implementations, and all such variations are considered to be within the scope of example embodiments.

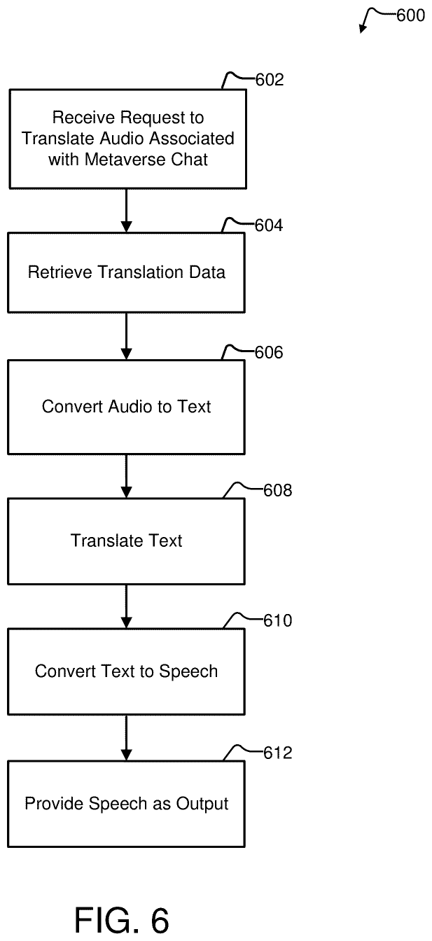

### FIG. 6: Example Method to Translate Voice Chat

FIG. 6 is a flowchart of an example method 600 to automatically translate voice chat in a metaverse place, in accordance with some implementations. In some implementations, method 600 can be implemented, for example, on a server system, e.g., online virtual experience platform 102 as shown in FIG. 1. In some implementations, some or all of the method 600 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 600. Method 600 may begin at block 602.

At block 602, a request to translate audio is received. The audio is associated with a chat function of metaverse place of the virtual metaverse from a first user of a plurality of users. The audio is received from the first user. The plurality of users is associated with the metaverse place and/or with the chat with the first user. Furthermore, the first user may be associated with a first user device (e.g., such as client device 110). Block 602 is followed by block 604.

At block 604, translation data associated with a second user of the plurality of users is retrieved. The translation data includes at least a language setting associated with the second user. Furthermore, the second user is associated with a second user device (e.g., such as client device 116). Block 604 is followed by block 606.

At block 606, the audio received from the first user is converted into text. The audio includes input speech in a first language spoken by the first user. For example, a machine learning model may be trained to extract phonemes from the audio, and use the extracted phonemes to recreate text associated with the input speech and extract context from the audio. Block 606 is followed by block 608.

At block 608, the text is translated into a second language. The second language is defined by the language preference and the translated text includes context data and/or emotion data. For example, a machine learning model may be used to extract context data based on the first user's speech and may also be used to extract emotion data based on the first user's speech. The context data and/or emotion data may be encoded in any suitable format including accents, fluctuations, and other notations that may be embedded in the text and/or included separately from the text with appropriate timestamps or synchronization marks. Block 608 is followed by block 610.

At block 610, the translated text is converted into output speech including the context data and/or emotion data. For example, a per-user or user-specific text to speech model may be provided the text, context data, and/or emotion data. The text to speech model may also be referred to as a speech synthesizer or speech synthesis model. Using the context data and/or emotion data together with speech data, the speech synthesizer may generate a speech waveform based on the speech, in the second language, and including at least one or more of the context data and/or emotion data. Block 610 is followed by block 612.

At block 612, the output speech is provided to the second user device. For example, the speech waveform may be converted into a specific audio format for routings with the relay server 210 and/or processing by the media server 202. Thereafter, the second user device (e.g., client device 116) may receive and output the audio for play back to the second user.

As described above, systems, methods, and computer-readable media may provide automatic translation of voice chat in virtual experiences. Variations of the above-described techniques may include additional features that produce improved user experiences and reduced latency in translation.

For example, the following improvements may be implemented into the method 600 of FIG. 6 and/or the pipeline 300 of FIG. 3:

Different Voice Models: Each output model may be trained as a specific voice. Accordingly, special language models may be implemented such that any user could speak as virtually any character voice available as an output model. De-noising/training for different age ranges and dialects may produce different output models that may be used to alter the apparent age of a voice to conform with a user or match a user setting. Different dialects may also produce different output models that may be used to alter a speech waveform to more closely match regional dialects.

Safety: Because expressiveness of voice can be tracked, the system may mute voice output when a player is speaking aggressively. Furthermore, speech-to-text (STT) can be applied to an output voice to check for inappropriate content and/or context prior to providing the audio to output at the second user device. Furthermore, voice output can be modified to anonymize the original speakers voice without losing expressiveness of the voice.

Latency: a predictive model of phoneme mappings to other phonemes in other languages can be used to reduce latency. For example, English has about 42 distinct phonemes and Spanish has about 24 phonemes, and with audio data and splitting based on translations a probabilistic model mapping phonemes as a stream to their mappings in other languages can be used to reduce latency. As such, sounds and how sounds map out may be a focus such that latencies inherent in word-to-word translations may be avoided in some scenarios. For example, the stream may be translated as it comes in without waiting for an entire block or sentence to be completely uttered.

In these examples, low latency voice translation can be possible for languages where the structure is not the same. Take for example a language that does adjective-noun-verb compared to verb-noun-adjective. The sounds can map probabilistically and ignore the structure of the sentences themselves. For high confidence results, an audio translation can sometimes be finished before the person is done speaking.

In these examples, there may still be some structuring mismatches but in many cases those can be caught early before the audio stream ends. As a step to this phoneme by phoneme processing, the final audio can be restructured during processing following the language rules of each language.

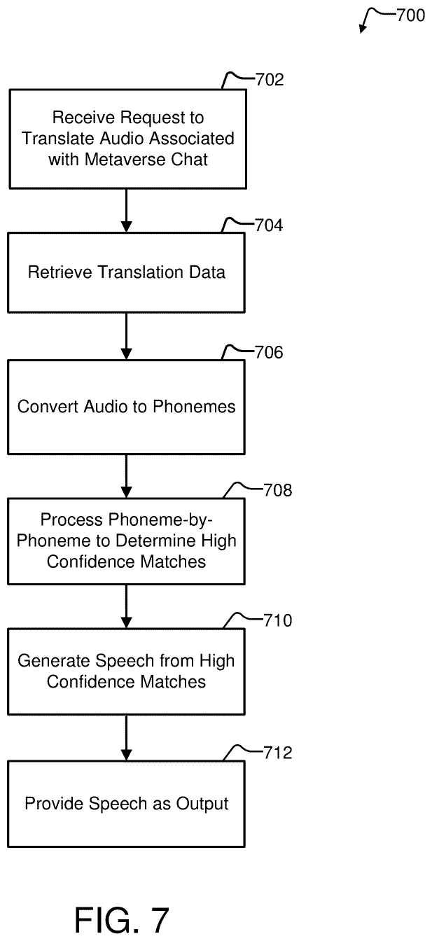

### FIG. 7: Example Method to Translate Voice Chat Based on Phoneme Prediction

FIG. 7 is a flowchart of an example method 700 to automatically translate voice chat in a metaverse place, in accordance with some implementations. In some implementations, method 700 can be implemented, for example, on a server system, e.g., online virtual experience platform 102 as shown in FIG. 1. In some implementations, some or all of the method 700 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 700. Method 700 may begin at block 702.

At block 702, a request to translate audio is received. The audio is associated with a chat function of metaverse place of the virtual metaverse from a first user of a plurality of users. The audio is received from the first user. The plurality of users is associated with the metaverse place and/or with the chat with the first user. Furthermore, the first user may be associated with a first user device (e.g., such as client device 110). Block 702 is followed by block 704.

At block 704, translation data associated with a second user of the plurality of users is retrieved. The translation data includes at least a language setting associated with the second user. Furthermore, the second user is associated with a second user device (e.g., such as client device 116). Block 704 is followed by block 706.

At block 706, the audio received from the first user is converted into phonemes. The audio includes input speech in a first language spoken by the first user. For example, a machine learning model may be trained to extract phonemes from the audio, and use the extracted phonemes to further extract context from the audio. Block 706 is followed by block 708.

At block 708, phonemes from block 706 are processed phoneme-by-phoneme to determine high confidence matches of phoneme between a first language and a second language. For example, phoneme-by-phoneme processing may include predictive phoneme processing based on a probabilistically generated translated audio. Final results may be selected based on confidence levels such that higher-confidence levels are selected first.

Phoneme-by-phoneme processing may also include restructuring audio based on probabilistically generated translated audio that varies based upon the target language. In this manner, a streaming structure can be adjusted for different languages. Furthermore, in this manner, a computer-implemented method may include predictive translation during speech-to-speech synthesis, translation during speech-to-speech synthesis, and other speech-to-speech synthesis methodologies. Block 708 is followed by block 710.

At block 710, output speech including the context data and/or emotion data is generated based on the high confidence phoneme predictions. For example, a per-user or user-specific speech model may be provided the phonemes, context data, and/or emotion data. The speech model may also be referred to as a speech synthesizer or speech synthesis model. Using the context data and/or emotion data together with phoneme data, the speech synthesizer may generate a speech waveform based on the phonemes, in the second language, and including at least one or more of the context data and/or emotion data. Block 710 is followed by block 712.

At block 712, the output speech is provided to the second user device. For example, the speech waveform may be converted into a specific audio format for routings with the relay server 210 and/or processing by the media server 202. Thereafter, the second user device (e.g., client device 116) may receive and output the audio for play back to the second user.

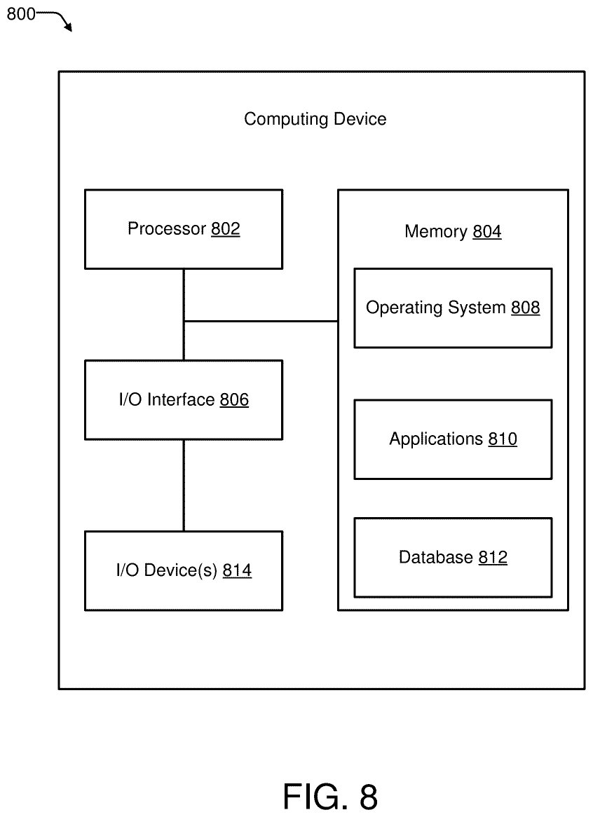

Hereinafter, a more detailed description of various computing devices that may be used to implement different devices illustrated in FIGS. 1-6 is provided with reference to FIG. 8.

### FIG. 8: Example Computing Device

FIG. 8 is a block diagram of an example computing device 800 which may be used to implement one or more features described herein, in accordance with some implementations. In one example, device 800 may be used to implement a computer device, (e.g., 102, 110, and/or 116 of FIG. 1), and perform appropriate method implementations described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 800 includes a processor 802. a memory 804, input/output (I/O) interface 806, and audio/video input/output devices 814 (e.g., display screen, touchscreen, display goggles or glasses, audio speakers, headphones, microphone, etc.).

Processor 802 can be one or more processors and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time.” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802. and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, applications 810 and associated data 812. In some implementations, the applications 810 can include instructions that enable processor 802 to perform the functions described herein, e.g., some or all of the methods of FIGS. 6 and/or 7.

For example, memory 804 can include software instructions for automatically translating voice chat in a metaverse place. Any of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. For example, network communication devices, storage devices (e.g., memory and/or data store 108), and input/output devices can communicate via interface 806. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 8 shows one block for each of processor 802, memory 804, I/O interface 806, software blocks 808 and 810, and database 812. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While the online virtual experience platform 102 is described as performing operations as described in some implementations herein, any suitable component or combination of components of online virtual experience platform 102 or similar system, or any suitable processor or processors associated with such a system, may perform the operations described.

A user device can also implement and/or be used with features described herein. Example user devices can be computer devices including some similar components as the device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 814, for example, can be connected to (or included in) the device 800 to display images pre-and post-processing as described herein, where such display device can include any suitable display device, e.g., an LCD, LED, or plasma display screen. CRT, television, monitor, touchscreen. 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented. for example, on a server system, and/or on both a server system and a client system. In some implementations, different components of one or more servers and/or clients can perform different blocks, operations, or other parts of the methods.

One or more methods described herein (e.g., methods 400-700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

### EXAMPLE CLAUSES

Clause 1. A computer-implemented method of voice chat translation in a virtual metaverse, comprising: receiving a request to translate audio associated with a chat function of metaverse place of the virtual metaverse, the audio received from a first user of a plurality of users, wherein the plurality of users are associated with the metaverse place; retrieving translation data associated with a second user of the plurality of users, wherein the translation data includes at least a language preference associated with the second user, and wherein the second user is associated with a user device; converting audio received from the first user into text, wherein the audio includes input speech in a first language spoken by the first user; translating the text into a second language, wherein the second language is defined by the language preference and wherein the translated text includes context data from the audio; converting the translated text into output speech including the context data; and providing the output speech to the user device.

Clause 2. The subject matter of any preceding clause, wherein the request identifies the first user and the second user, and the request originates from a computing device associated with the first user.

Clause 3. The subject matter of any preceding clause, further comprising retrieving voice output preferences associated with the first user, wherein the voice output preferences at least partially override the translation data associated with the second user.

Clause 4. The subject matter of any preceding clause, further comprising, prior to translating the text into the second language, moderating the text to remove words based on a text moderation filter.

Clause 5. The subject matter of any preceding clause, wherein the translating comprises providing, as input to a trained machine learning model, the text and receiving, as an output from the trained machine learning model, the translated text.

Clause 6. The subject matter of any preceding clause, wherein the context data comprises emotion data extracted from the audio.

Clause 7. The subject matter of any preceding clause, further comprising pre-processing the audio to extract the emotion data.

Clause 8. The subject matter of any preceding clause, wherein converting the translated text into output speech comprises using a speech waveform modulator to create a modulated speech waveform that at least partially includes the context data.

Clause 9. The subject matter of any preceding clause, further comprising translating the text into a plurality of different languages to create a plurality of different translated texts, and converting the plurality of different translated texts into a plurality of different output speech.

Clause 10. The subject matter of any preceding clause, further comprising providing the plurality of different output speech to a plurality of user devices, wherein each output speech comprises utterances in a language associated with a respective user device of the plurality of user devices.

Clause 11. A non-transitory computer-readable medium with instructions stored thereon that, responsive to execution by a processing device, causes the processing device to perform operations comprising: receiving a request to translate audio associated with a chat function of metaverse place of the virtual metaverse, the audio received from a first user of a plurality of users, wherein the plurality of users are associated with the metaverse place; retrieving translation data associated with a second user of the plurality of users, wherein the translation data includes at least a language preference associated with the second user, and wherein the second user is associated with a user device; converting audio received from the first user into text, wherein the audio includes input speech in a first language spoken by the first user: translating the text into a second language, wherein the second language is defined by the language preference and wherein the translated text includes context data from the audio; converting the translated text into output speech including the context data; and providing the output speech to the user device.

Clause 12. The subject matter of any preceding clause, wherein the request identifies the first user and the second user, and the request originates from a computing device associated with the first user.

Clause 13. The subject matter of any preceding clause, the operations further comprising retrieving voice output preferences associated with the first user, wherein the voice output preferences at least partially override the translation data associated with the second user.

Clause 14. The subject matter of any preceding clause, the operations further comprising. prior to translating the text into the second language, moderating the text to remove words based on a text moderation filter.

Clause 15. The subject matter of any preceding clause, wherein the translating comprises providing, as input to a trained machine learning model, the text and receiving, as an output from the trained machine learning model, the translated text.

Clause 16. The subject matter of any preceding clause, wherein the context data comprises emotion data extracted from the audio.

Clause 17. The subject matter of any preceding clause, the operations further comprising pre-processing the audio to extract the emotion data.

Clause 18. The subject matter of any preceding clause, wherein converting the translated text into output speech comprises using a speech waveform modulator to create a modulated speech waveform that at least partially includes the context data.

Clause 19. The subject matter of any preceding clause, the operations further comprising: translating the text into a plurality of different languages to create a plurality of different translated texts; converting the plurality of different translated texts into a plurality of different output speech; and providing the plurality of different output speech to a plurality of user devices, wherein each output speech comprises utterances in a language associated with a respective user device of the plurality of user devices.

Clause 20. A system, comprising: a memory with instructions stored thereon; and a processing device, coupled to the memory and operable to access the memory, wherein the instructions when executed by the processing device, cause the processing device to perform operations including: receiving a request to translate audio associated with a chat function of metaverse place of the virtual metaverse, the audio received from a first user of a plurality of users, wherein the plurality of users are associated with the metaverse place; retrieving translation data associated with a second user of the plurality of users, wherein the translation data includes at least a language preference associated with the second user, and wherein the second user is associated with a user device; converting audio received from the first user into text, wherein the audio includes input speech in a first language spoken by the first user; translating the text into a second language, wherein the second language is defined by the language preference and wherein the translated text includes context data from the audio; converting the translated text into output speech including the context data; and providing the output speech to the user device.

### CONCLUSION

Although the description has been described with respect to particular implementations thereof, these particular implementations are merely illustrative, and not restrictive. Concepts illustrated in the examples may be applied to other examples and implementations.

In situations in which certain implementations discussed herein may obtain or use user data (e.g., user demographics, user behavioral data on the platform, user search history, items purchased and/or viewed, user's friendships on the platform, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method of voice chat translation in a virtual metaverse, comprising:
receiving a request to translate audio associated with a chat function of metaverse place of the virtual metaverse, the audio received from a first user of a plurality of users, wherein the plurality of users are associated with the metaverse place;
retrieving translation data associated with a second user of the plurality of users, wherein the translation data includes at least a language preference associated with the second user, and wherein the second user is associated with a user device;
converting audio received from the first user into text, wherein the audio includes input speech in a first language spoken by the first user;
translating the text into a second language, wherein the second language is defined by the language preference and wherein the translated text includes context data from the audio;
converting the translated text into output speech including the context data; and
providing the output speech to the user device.

2. The computer-implemented method of claim 1, wherein the request identifies the first user and the second user, and the request originates from a computing device associated with the first user.

3. The computer-implemented method of claim 1, further comprising retrieving voice output preferences associated with the first user, wherein the voice output preferences at least partially override the translation data associated with the second user.

4. The computer-implemented method of claim 1, further comprising, prior to translating the text into the second language, moderating the text to remove words based on a text moderation filter.

5. The computer-implemented method of claim 1, wherein the translating comprises providing, as input to a trained machine learning model, the text and receiving, as an output from the trained machine learning model, the translated text.

6. The computer-implemented method of claim 1, wherein the context data comprises emotion data extracted from the audio.

7. The computer-implemented method of claim 6, further comprising pre-processing the audio to extract the emotion data.

8. The computer-implemented method of claim 1, wherein converting the translated text into output speech comprises using a speech waveform modulator to create a modulated speech waveform that at least partially includes the context data.

9. The computer-implemented method of claim 1, further comprising translating the text into a plurality of different languages to create a plurality of different translated texts, and converting the plurality of different translated texts into a plurality of different output speech.

10. The computer-implemented method of claim 9, further comprising providing the plurality of different output speech to a plurality of user devices, wherein each output speech comprises utterances in a language associated with a respective user device of the plurality of user devices.

11. A non-transitory computer-readable medium with instructions stored thereon that, responsive to execution by a processing device, causes the processing device to perform operations comprising:
receiving a request to translate audio associated with a chat function of metaverse place of the virtual metaverse, the audio received from a first user of a plurality of users, wherein the plurality of users are associated with the metaverse place;
retrieving translation data associated with a second user of the plurality of users, wherein the translation data includes at least a language preference associated with the second user, and wherein the second user is associated with a user device;
converting audio received from the first user into text, wherein the audio includes input speech in a first language spoken by the first user;
translating the text into a second language, wherein the second language is defined by the language preference and wherein the translated text includes context data from the audio;
converting the translated text into output speech including the context data; and
providing the output speech to the user device.

12. The non-transitory computer-readable medium of claim 11, wherein the request identifies the first user and the second user, and the request originates from a computing device associated with the first user.

13. The non-transitory computer-readable medium of claim 11, the operations further comprising retrieving voice output preferences associated with the first user, wherein the voice output preferences at least partially override the translation data associated with the second user.

14. The non-transitory computer-readable medium of claim 11, the operations further comprising, prior to translating the text into the second language, moderating the text to remove words based on a text moderation filter.

15. The non-transitory computer-readable medium of claim 11, wherein the translating comprises providing, as input to a trained machine learning model, the text and receiving, as an output from the trained machine learning model, the translated text.

16. The non-transitory computer-readable medium of claim 11, wherein the context data comprises emotion data extracted from the audio.

17. The non-transitory computer-readable medium of claim 16, the operations further comprising pre-processing the audio to extract the emotion data.

18. The non-transitory computer-readable medium of claim 11, wherein converting the translated text into output speech comprises using a speech waveform modulator to create a modulated speech waveform that at least partially includes the context data.

19. The non-transitory computer-readable medium of claim 11, the operations further comprising:
translating the text into a plurality of different languages to create a plurality of different translated texts;
converting the plurality of different translated texts into a plurality of different output speech; and
providing the plurality of different output speech to a plurality of user devices, wherein each output speech comprises utterances in a language associated with a respective user device of the plurality of user devices.

20. A system, comprising:
a memory with instructions stored thereon; and
a processing device, coupled to the memory and operable to access the memory, wherein the instructions when executed by the processing device, cause the processing device to perform operations including;
receiving a request to translate audio associated with a chat function of metaverse place of the virtual metaverse, the audio received from a first user of a plurality of users, wherein the plurality of users are associated with the metaverse place;
retrieving translation data associated with a second user of the plurality of users, wherein the translation data includes at least a language preference associated with the second user, and wherein the second user is associated with a user device;
converting audio received from the first user into text, wherein the audio includes input speech in a first language spoken by the first user;
translating the text into a second language, wherein the second language is defined by the language preference and wherein the translated text includes context data from the audio;
converting the translated text into output speech including the context data; and providing the output speech to the user device.
